(19) United States
(12) Patent Application Publication
(10) Pub. No.: US 2020/0266922 A1
(43) Pub. Date: Aug. 20, 2020

(54) SEMI-BLIND DETECTION OF URLLC IN PUNCTURED eMBB

(71) Applicant: Telefonaktiebolaget LM Ericsson (publ), Stockholm (SE)

(72) Inventors: Zhan Zhang, Beijing (CN); Shehzad Ali Ashraf, Aachen (DE); Yufei Blankenship, Kildeer, IL (US); Caner Kilinc, Luleå (SE); Zhenhua Zou, Solna (SE)

(21) Appl. No.: 16/496,995

(22) PCT Filed: Mar. 24, 2017
(86) PCT No.: PCT/CN2017/078003

§ 371 Date: Sep. 24, 2019

(51) Int. Cl. H04L 1/00

(52) U.S. Cl. CPC H04L 1/0038; H04L 1/0013; H04L 1/0016; H04L 1/0003; H04L 1/0017; H04L 1/0061

(57) ABSTRACT

The proposed embodiment provides an efficient way to implicitly detect at the receiver the puncturing information (i. e. time/frequency resources, MCS, TBS etc.) of the Ultra Reliable Low Latency Communication (URLLC) in the punctured Enhanced Mobile Broadband (eMBB) area. The performance of eMBB traffic can be improved by implicitly providing the puncturing information without any additional signaling or indications (e.g. does not require any additional bits).

### TECHNICAL FIELD

Embodiments of the invention relate to the field of wireless communication, and more specifically, to semi-blind detection of Ultra Reliable Low Latency Communication (URLLC) transmissions that puncture Enhanced Mobile Broadband (eMBB) transmissions.

### BACKGROUND

### Long Term Evolution (LTE)

LTE wireless communication technology uses Orthogonal Frequency Division Multiplexing (OFDM) in the downlink and Discrete Fourier Transform (DFT)-spread OFDM in the uplink. The basic LTE downlink physical resource can thus be seen as a time-frequency grid as illustrated in FIG. 1, where each Resource Element (RE) corresponds to one OFDM subcarrier during one OFDM symbol interval. In the time domain, LTE downlink transmissions are organized into radio frames of ten milliseconds (ms), each radio frame consisting of ten equally-sized subframes of length T_{SUBFRAME}=1 ms, as illustrated in FIG. 2.

Furthermore, resource allocation in LTE is typically described in terms of Resource Blocks (RBs), where a RB corresponds to one slot (0.5 ms) in the time domain and 12 contiguous subcarriers in the frequency domain. A pair of two adjacent RBs in time direction (1.0 ms) is known as a RB pair. RBs are numbered in the frequency domain, starting with 0 from one end of the system bandwidth.

The notion of Virtual RBs (VRBs) and Physical RBs (PRBs) has been introduced in LTE. The actual resource allocation to a User Equipment device (UE) is made in terms of VRB pairs. There are two types of resource allocations, localized and distributed. In the localized resource allocation, a VRB pair is directly mapped to a PRB pair, hence two consecutive and localized VRBs are also placed as consecutive PRBs in the frequency domain. On the other hand, the distributed VRBs are not mapped to consecutive PRBs in the frequency domain, thereby providing frequency diversity for a data channel transmitted using these distributed VRBs.

Downlink transmissions are dynamically scheduled. Specifically, in each downlink subframe, the base station transmits downlink control information that indicates the UEs to which data is transmitted in the current subframe and upon which RBs the data is transmitted to those UEs in the current downlink subframe. This control signaling is typically transmitted in the first 1, 2, 3, or 4 OFDM symbols in each subframe, and the number n=1, 2, 3, or 4 is known as the Control Format Indicator (CFI). The downlink subframe also contains common reference symbols, which are known to the receiver and used for coherent demodulation of, e.g., the control information. A downlink subframe with CFI=3 OFDM symbols as control is illustrated in FIG. 3. From LTE Release (Rel) 11 onwards, the above described resource assignments can also be scheduled on the Enhanced Physical Downlink Control Channel (EPDCCH). For Rel 8 to Rel 10, only the Physical Downlink Control Channel (PDCCH) is available.

There is a desire to enhance the current mobile communication systems to provide means of communication between wide ranges of machines. A subgroup of this is Critical Machine Type Communication (CMTC) where the communication requirements of very low latency, very high reliability, and very high availability must be fulfilled. Example use cases include:

Factory automation, where actuators, sensors and control systems communicate with each other. Typical requirement 1 ms latency.

Motion control within construction robots, 1 ms latency.

Remote control of machines, 5-100 ms latency.

Smart energy grids, 3-5 ms.

. . . and others.

Candidate communication systems to fulfill such requirements and use-cases include LTE and a newly developed radio access called New Radio (NR) by the Third Generation Partnership Project (3GPP). In NR, a scheduling unit is defined as either slot or mini-slot. An NR slot will consist of several OFDM symbols. One possible outcome is that a slot consists of seven OFDM symbols, but other structures (e.g. with 14 OFDM symbols) can be envisioned as well. It is also being discussed that NR slot and/or mini-slot may or may not contain both transmission in UL and DL. Therefore, 3 configurations of slots are being discussed, namely: (1) DL-only slot (2) UL-only slot (3) Mixed DL and UL slot.

FIG. 4 shows a downlink-only slot as an example with seven OFDM symbols. In FIG. 4, T_{sf} and Tₛ denote the slot and OFDM symbol duration, respectively.

Furthermore, NR-enabled UE category may support different traffic types depending on the application requirements. One example is the co-existing Enhanced Mobile Broadband (eMBB) and Ultra Reliable Low Latency Communication (URLLC) traffic. In order to meet the URLLC requirement of 1-10⁻⁵ reliability within 1 ms, the network interference should be controlled. It means that there must always be enough resources (in time and/or frequency) available to meet the requirements of both URLLC and eMBB traffic. One straightforward way is to have a dedicated band (in same carrier) for both URLLC and eMBB traffic. This leads to lower spectral efficiency because the resources will not be fully utilized due to sporadic nature of the URLLC traffic. Therefore, it is agreed in 3GPP to define a so-called co-existence region where both URLLC and eMBB traffic can be scheduled. The main purpose is that the unused resources by URLLC traffic in the coexistence region can be utilized to schedule eMBB traffic. However, URLLC traffic is always given the priority over eMBB traffic due to its strict latency bounds and high reliability requirements. It means that, if eMBB and URLLC traffic is transmitting on different time-scales (e.g. slot and mini-slot level), we need to puncture the on-going eMBB traffic on the shared resources to be able to allow more urgent URLLC transmission.

For simplicity, in the description, we assume that URLLC traffic operates at mini-slot level and eMBB traffic operates at slot level.

### Problems with Existing Solutions

It is well shown that if there is no puncturing indication at the receiver side, the whole eMBB data (or transport block) will be considered corrupted and most likely be discarded. That leads to the performance degradation of eMBB applications/services. Furthermore, the discarded packets cause retransmissions resulting in additional energy consumption of the transmitter and interferences.

A straight forward solution would be to explicitly indicate the puncturing to the receiver (i.e. UE in DL and gNB in UL) by an additional control signaling (e.g. puncturing indication). However, that would lead to an extra signaling overhead. In addition, it might also increase URLLC latency if URLLC transmission uses a grant-based scheduling and the same control signaling (e.g. grants) is used by the receiver to get puncturing information to improve the performance of eMBB service.

### SUMMARY

The proposed embodiment provides an efficient way to implicitly detect at the receiver the puncturing information (i.e. time/frequency resources, Modulation and Coding Scheme (MCS), Transport Block Size (TBS) etc.) of the Ultra Reliable Low Latency Communication (URLLC) in the punctured Enhanced Mobile Broadband (eMBB) area.

According to one aspect of the present disclosure, a method of operation of a User Equipment (UE) for puncturing an eMBB transmission with a URLLC transmission comprises receiving first data to be transmitted as an URLLC uplink transmission; encoding the first data using an encoding sequence to produce encoded first data; and transmitting, within a subset of a first set of resources allocated for the eMBB transmission, the encoded first data.

In one embodiment, encoding the first data using the encoding sequence comprises performing a bitwise operation of the encoding sequence with a Cyclic Redundancy Check (CRC) portion and/or a data portion of the first data.

In one embodiment, performing the bitwise operation of the encoding sequence with the CRC portion and/or the data portion of the first data comprises performing one of: a modulo-2 addition; and an exclusive OR (XOR) operation.

In one embodiment, encoding the first data using the encoding sequence comprises scrambling the first data using a pseudo-random sequence, where the pseudo-random sequence is generated as a function of the encoding sequence.

In one embodiment, the encoding sequence comprises or is generated based on at least one of: a UE identifier (UE-ID) a Radio Network Temporary Identifier (RNTI); a cell identifier; and a traffic identifier.

In one embodiment, a location of the subset of the first set of resources is pre-configured, dynamically selected, and/or signaled.

In one embodiment, the first set of resources was allocated for an eMBB transmission by the UE.

In one embodiment, transmitting the encoded first data punctures the eMBB transmission by the UE.

In one embodiment, the first set of resources was allocated for an eMBB transmission by a second UE.

In one embodiment, the UE is a member of a group of UEs and wherein the first UE can puncture the second UE only if the second UE is a member of the group of UEs.

In one embodiment, the UE is a URLLC-capable UE and the other UEs in the group of UEs are not URLLC-capable.

In one embodiment, transmitting the encoded first data punctures the eMBB transmission by the second UE.

In one embodiment, the eMBB transmission by the second UE is at a first transmission power and wherein transmitting the encoded first data comprises transmitting the encoded first data at a second transmission power higher than the first transmission power.

According to another aspect of the present disclosure, a method of operation of a network node for detecting that an eMBB transmission has been punctured by a URLLC transmission comprises identifying a first set of resources as being allocated for an eMBB uplink transmission, identifying a subset of the first set of resources as potentially including an encoded URLLC transmission, decoding, using a decoding sequence, first data occupying the subset of resources, and detecting the presence or absence of a URLLC uplink transmission within the subset of resources based on the decoding results.

In one embodiment, decoding the first data occupying the subset of resources using the decoding sequence comprises calculating a CRC value for a first portion of the first data, and performing a bitwise operation of the calculated CRC value and a second portion of the first data, wherein, if the results of the operation match the decoding sequence, the first data contains the URLLC transmission.

In one embodiment, performing the bitwise operation of the calculated CRC value and the second portion of the first data comprises performing one of: a modulo-2 addition; and an XOR operation.

In one embodiment, decoding the data occupying the subset of resources using the decoding sequence comprises de-scrambling the first data using a pseudo-random sequence to produce second data, where the pseudo-random sequence is generated as a function of the decoding sequence, and determining whether the second data contains the URLLC transmission.

In one embodiment, determining whether the second data contains a URLLC transmission comprises calculating a CRC value for a first portion of the second data, and determining whether the calculated CRC value matches a second portion of the second data.

In one embodiment, the encoding sequence comprises or is generated based on at least one of: a UE-ID; a RNTI; a cell identifier; and a traffic identifier.

In one embodiment, at least one of a location of the subset of the first set of resources and an expected length of encoded URLLC transmissions is pre-configured, dynamically selected, and/or signaled.

In one embodiment, detecting the presence or absence of the URLLC transmission within the subset of resources comprises the presence or absence of the URLLC transmission based on whether a power level of the subset of resources is higher than a power level of the first set of resources other than the subset of resources.

In one embodiment, the network node performs the decoding step using a decoding sequence associated with the User Equipment, UE.

In one embodiment, the network node performs the decoding step using a decoding sequence associated with a second UE different from the UE.

In one embodiment, the network node performs the decoding and detecting steps for each of a plurality of UEs, each decoding and detecting step performed using a decoding sequence associated with the associated one of the plurality of UEs.

According to another aspect of the present disclosure, a method of operation of a network node for puncturing an eMBB transmission with a URLLC transmission comprises receiving first data to be transmitted as a URLLC downlink transmission, encoding the first data using an encoding sequence to produce encoded first data, and transmitting, within a subset of a first set of resources allocated for the eMBB transmission, the encoded first data instead of the eMBB transmission.

In one embodiment, encoding the first data using the encoding sequence comprises performing a bitwise operation of the encoding sequence with a CRC portion and/or a data portion of the first data.

In one embodiment, performing the bitwise operation of the encoding sequence with the CRC portion and/or the data portion of the first data comprises performing one of: a modulo-2 addition; and an XOR operation.

In one embodiment, encoding the first data using the encoding sequence comprises scrambling the first data using a pseudo-random sequence, where the pseudo-random sequence is generated as a function of the encoding sequence.

In one embodiment, the encoding sequence comprises or is generated based on at least one of: a UE-ID; a RNTI; a cell identifier; and a traffic identifier.

In one embodiment, a location of the subset of the first set of resources is pre-configured, dynamically selected, and/or signaled.

In one embodiment, the first set of resources was allocated for the eMBB transmission to the UE.

In one embodiment, transmitting the encoded first data punctures the eMBB transmission to the UE.

In one embodiment, the first set of resources was allocated for an eMBB transmission to a second UE.

In one embodiment, transmitting the encoded first data punctures an eMBB transmission to the second UE.

In one embodiment, the eMBB transmission to the second UE is at a first transmission power and wherein transmitting the encoded first data comprises transmitting the encoded first data at a second transmission power higher than the first transmission power.

According to another aspect of the present disclosure, a method of operation of a UE for detecting that an eMBB transmission has been punctured by a URLLC transmission comprises identifying a first set of resources as allocated for an eMBB downlink transmission; identifying a subset of the first set of resources as potentially including an encoded URLLC transmission; decoding, using a decoding sequence, first data occupying the subset of resources; and detecting the presence or absence of a URLLC transmission within the subset of resources based on the decoding results.

In one embodiment, decoding the first data occupying the subset of resources using the decoding sequence comprises: calculating a CRC value for a first portion of the first data and performing a bitwise operation of the calculated CRC value and a second portion of the first data, wherein, if the results of the operation match the decoding sequence, the first data contains a URLLC transmission.

In one embodiment, performing the bitwise operation of the calculated CRC value and the second portion of the first data comprises performing one of: a modulo-2 addition; and an XOR operation.

In one embodiment, decoding the data occupying the subset of resources using the decoding sequence comprises: de-scrambling the first data using a pseudo-random sequence to produce second data, where the pseudo-random sequence is generated as a function of the decoding sequence; and determining whether the second data contains the URLLC transmission.

In one embodiment, determining whether the second data contains the URLLC transmission comprises: calculating a CRC value for a first portion of the second data; and determining whether the calculated CRC value matches a second portion of the second data.

In one embodiment, the encoding sequence comprises or is generated based on at least one of: a UE-ID; a RNTI; a cell identifier; and a traffic identifier.

In one embodiment, at least one of a location of the subset of the first set of resources and an expected length of encoded URLLC transmissions is pre-configured, dynamically selected, and/or signaled.

In one embodiment, detecting the presence or absence of the URLLC transmission within the subset of resources comprises the presence or absence of the URLLC transmission based on whether a power level of the subset of resources is higher than a power level of the first set of resources other than the subset of resources.

In one embodiment, the first set of resources was allocated for the eMBB transmission to the UE.

In one embodiment, the first set of resources was allocated for the eMBB transmission to a second UE.

According to another aspect of the present disclosure, a node for puncturing an eMBB transmission with a URLLC transmission comprises at least one processor and memory comprising instructions executable by the at least one processor whereby the node is adapted to operate according to any of the methods described herein.

According to another aspect of the present disclosure, a node for puncturing an eMBB transmission with a URLLC transmission comprises one or more modules whereby the node is adapted to operate according to any of the methods described herein.

### Advantages of the Proposed Solution

The performance of eMBB traffic can be improved by implicitly providing the puncturing information without any additional signaling or indications (e.g. does not require any additional bits).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the basic Long Term Evolution (LTE) physical resource;

FIG. 2 illustrates a conventional LTE downlink radio frame;

FIG. 3 illustrates an example of a downlink subframe;

FIG. 4 shows a downlink-only slot as an example with seven Orthogonal Frequency Division Multiplexing (OFDM) symbols;

FIG. 5 illustrates one example of a wireless communication system in which embodiments of the present disclosure may be implemented;

FIG. 6 is a flow chart that illustrates the operation of a User Equipment (UE) or other wireless device according to some embodiments of the present disclosure;

FIG. 7 is a flow chart that illustrates the operation of a base station or other network node according to some embodiments of the present disclosure;

FIG. 8 is a flow chart that illustrates the operation of a base station or other network node according to other embodiments of the present disclosure;

FIG. 9 is a flow chart that illustrates the operation of a UE or other wireless device according to other embodiments of the present disclosure;

FIGS. 10 and 11 illustrate example embodiments of a UE or other type of wireless device; and

FIGS. 12 through 14 illustrate example embodiments of a network node.

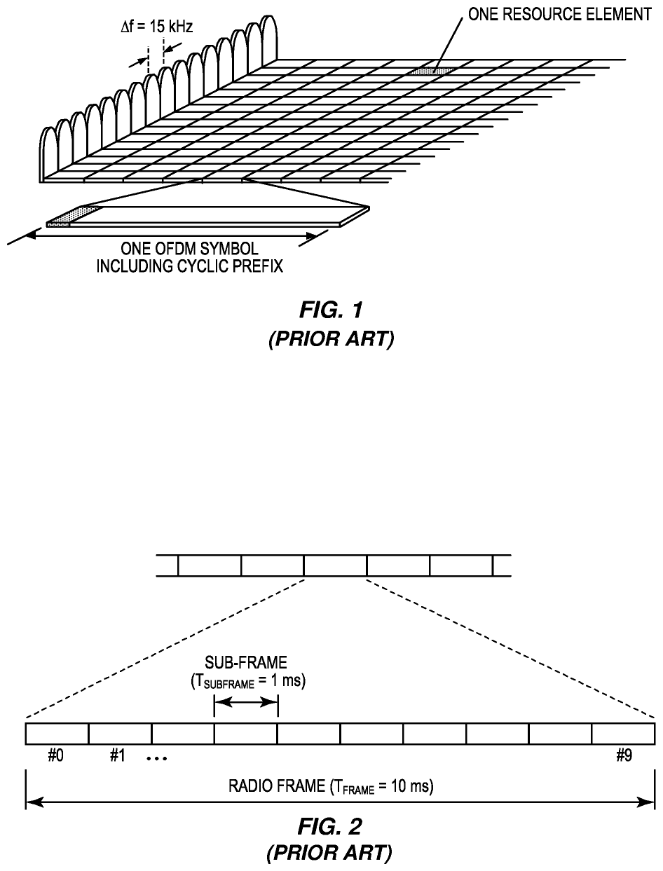

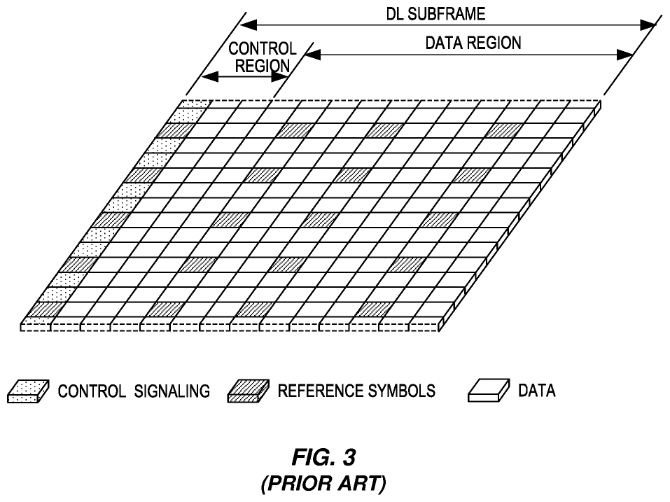

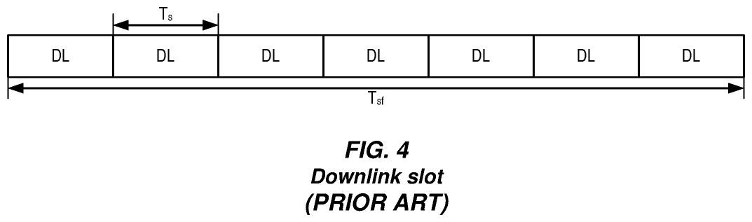

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Modulation and Coding Scheme (MCS) Table: As used herein, a “MCS table” is a table that maps a MCS index, e.g., determined based on channel quality, to a modulation scheme (e.g., Quadrature Phase Shift Keying (QPSK), 16 Quadrature Amplitude Modulation (16 QAM), 64 QAM, or 256 QAM) and a Transport Block Size (TBS) index.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

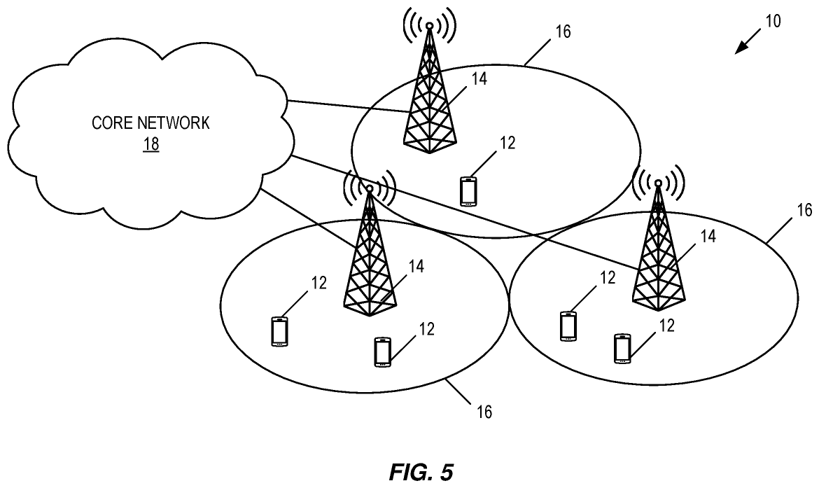

FIG. 5 illustrates one example of a wireless communication system 10 in which embodiments of the present disclosure may be implemented. The wireless communication system 10 may be a cellular communications system such as, for example, an LTE network or a 5G NR network. As illustrated, in this example, the wireless communication system 10 includes a plurality of wireless communication devices 12 (e.g., conventional UEs, MTC/Machine-to-Machine (M2M) UEs) and a plurality of radio access nodes 14 (e.g., eNBs, 5G base stations which are referred to as gNBs, or other base stations). The wireless communication system 10 is organized into cells 16, which are connected to a core network 18 via the corresponding radio access nodes 14. The radio access nodes 14 are capable of communicating with the wireless communication devices 12 (also referred to herein as wireless devices 12) along with any additional elements suitable to support communication between wireless communication devices or between a wireless communication device and another communication device (such as a landline telephone).

### 5.1 Ultra Reliable Low Latency Communication (URLLC) Data Indication

The main inventive step of this embodiment is to use a pre-defined sequence (such as UE-ID, either whole or partial RNTI sequence, or other sequence) to mask CRC of URLLC data transport blocks or code blocks (such as a 24-bit cyclic redundancy checking bits). The operation is done by a module-2 adding between the CRC bits and specific sequences. Hence, by embedding such specific masking, a semi-blind detection at a receiver could easily identify a puncturing-based URLLC transmission in a pre-scheduled Enhanced Mobile Broadband (eMBB) resource. Such identification could trigger the receiver to select a proper receiving processing so that the overall spectrum efficiency and successful enabling of the puncturing-based URLLC transmission could be facilitated.

In the main embodiment, the URLLC data can be punctured into the on-going MBB data transmissions and the puncturing information can be blindly decoded to improve the performance.

Before going into details, this embodiment also proposes another method to embed URLLC UE information in Section 5.1.1. Although we describe the solution in Section 5.2 with CRC-masking, this method is equally applicable to all following descriptions in Section 5.2.

### 5.1.1 Pseudo-Random Sequence Based Scrambling

In this method, the coded bits are scrambled by a pseudo-random sequence, where the pseudo-random sequence is generated as a function of the UE-ID (e.g., RNTI). Additionally, the pseudo-random sequence is generated as a function of the cell ID also, in order to differentiate transmission of UEs in one cell to the UEs in neighbor cells.

For each codeword q, the block of bits b^{(q)}(0), . . . ,b^{(q)}(M_{bit}^{(q)}−1), where M_{bit}^{(q)} is the number of bits in codeword q transmitted on the physical channel in one subframe, shall be scrambled prior to modulation, resulting in a block of scrambled bits \tilde{b}^{(q)}(0), . . . ,\tilde{b}^{(q)}(M_{bit}^{(q)}−1) according to \tilde{b}^{(q)}(i)=(b^{(q)}(i)+c^{(q)}(i))mod 2 where c^{(q)}(i) is the scrambling sequence. The scrambling sequence generator of c^{(q)}(i) shall be initialized at the start of each subframe, where the initialization value of cᵢₙᵢₜ is a function of the URLLC puncturing information according to

$${c}_{init} = \{ \begin{matrix}{n}_{R N T I} \cdot {2}^{14} + q \cdot {2}^{13} + ⌊ {n}_{s} / 2 ⌋ \cdot {2}^{9} + {N}_{I D}^{cell} & f or PDSCH \\ ⌊ {n}_{s} / 2 ⌋ \cdot {2}^{9} + {N}_{I D}^{MBSFN} & for PMC H\end{matrix}$$

where n_{RNTI} corresponds to the RNTI associated with the PDSCH transmission.

### 5.2 Four Puncturing Scenarios

We list four different scenarios depending on UL/DL and whether multiple UEs are involved. The solutions are explained with the main inventive step of using CRC-masking, along with other additional embodiments in reducing blinding detection complexities.

### 5.2.1 UL Same UE Puncturing

This is the case when UE punctures its own eMBB UL with UL URLLC, also called intra-node puncturing.

For UL, gNB is supposed to do a semi-blind detection first on whether the aforementioned masking sequence can be identified. Such a detection is assisted by a pre-allocation on a resource range for possible UL URLLC puncturing, i.e., a mini-slot resource region and pre-defined URLLC data TB length, default MCS parameters, etc. In addition, the puncturing masking sequence is signaled from gNB to UE with either an RRC or MAC CE signaling. As an alternative, by standard specification, a RNTI kind of sequence is used by default. Therefore, once UE punctures its own granted eMBB resource and sends URLLC data TB or code block (CB), CB groups (CBGs), gNB, with the knowledge of masking sequence, can detect puncture happened and trigger proper receiver processing and feedback for eMBB TB for retransmission (if needed).

### 5.2.1.1 Reducing Search Space for Blind-Detection

The search space size for URLLC data punctured into eMBB data is dependent on several factors such as MCS of URLLC data, as well as puncturable resources in time and frequency etc. (within its eMBB grant). The size of search space defines the blind decoding complexity since gNB has to search for several hypotheses of the URLLC transmission over the eMBB grant from same UE.

As one solution, we can limit the number of MCS, TBS, and time/frequency resources (i.e. puncture-able resources within the eMBB grant) of URLLC traffic to reduce the blind decoding complexity. For example, gNB can pre-configure or dynamically signal via eMBB DCI, a small part of the resources (i.e. grant given to eMBB traffic) for any URLLC traffic of the same UE on mini-slot level.

Another alternative solution is to explicitly signal the puncturable resources so that the amount of puncturing resources can be related to how much time the current URLLC traffic has till the next slot boundary, i.e., its own transmission opportunity without puncturing the eMBB traffic. As a rule, the closer to the next slot boundary, the less amount of resources it might need to be allocated. For example, in the extreme case, it might not allow puncturing at the sixth and seventh OFDM symbol with a slot with seven symbols. The reasoning is that the extra latency reduction of two symbols might not matter, but the extra latency of five or six symbols might be too much.

### 5.2.2 UL Different-UE Puncturing

This is the case when the UE punctures eMBB UL transmission of different UE with its UL URLLC, called inter-UE or inter-node puncturing.

First, to enable UL inter-UE puncturing, gNB is designed to semi-blindly detect all possible sequences for URLLC transmission before a regular eMBB TB decoding at any of granted resource for any of eMBB services. It allows UEs with URLLC data to pre-empt the resource in a much wider range (intra-UE resource and different UEs' resources granted at PUSCH), at the expense of gNB reception complicity,

All the above described embodiments in Section 5.2.1 remain applicable for this case. In addition to those, we have the following additional embodiments.

To reduce the complexity, we put a constraint on when and where puncturing-based transmission can happen. For example, UEs are only authorized to puncture certain UEs' eMBB resources. Another example is to group UEs and require that puncture is only allowed within its group. An obvious group strategy is to group UE(s) without URLLC service with an UE with a URLLC service. In this way, URLLC UEs will not collide with same type of UEs at the potential puncturing-based transmission. On top of these examples, gNB should instruct these authorized UEs of the possible UL resources beforehand either directly or indirectly.

Furthermore, for puncturing UL eMBB data by UL URLLC data of different UEs, special considerations can be used e.g. power control to allow for successful URLLC data decoding. Therefore, URLLC UE can use a boosted transmission power, while eMBB UE uses a normal pre-allocated power, to increase its probability of successful transmission of URLLC data.

As a follow-up embodiment, gNB can blind-detect the URLLC transmission through the detection of the discrepancy of reception power, i.e., an excessive power means a high probability of puncturing.

### 5.2.3 DL Same-UE Puncturing

For DL and same-UE puncturing, UE blind decodes the URLLC transmission within the eMBB grant.

All the above described embodiments in Section 5.2.1 remain applicable for this case as well.

In addition to those, aforementioned semi-blind detection of puncturing at the intra-UE or intra-node DL cases could be done associatively with DL mini-slot PDCCH. i.e., this mini-slot PDCCH could provide assisting parameter or info to facilitate the puncturing. For example, it could provide new region at slot-related resources for possible puncturing and instruct UEs to have a semi-blind checking on certain resource regions.

### 5.2.4 DL Different-UE Puncturing

For DL inter-node puncture, UE can blind decode any presence of URLLC traffic based on CRC as mentioned at above sections. All the above described embodiments in Section 5.2.1 and 5.2.2 to limit the blind decoding complexity remain applicable for this case, with transmission direction reversed.

In addition, CRC can be differentiated if it is scrambled with UE-ID or any other pre-configured sequence such as traffic ID. If a UE detects CRC with higher priority traffic (or sequence) than its own, it knows that it is low priority traffic (i.e. eMBB) has been punctured.

Moreover, the intended URLLC UE by the puncturing-based transmission is supposed to receive this URLLC TB at the punctured PRBs. And such PRBs (i.e. resource allocation) should be either specifically instructed to this UE or pre-configured to it for its monitoring of possible DL data transmission. In other words, the puncturing allowable PRB granted to the eMBB UEs actually overlaps with those resources monitored by URLLC UEs. URLLC UEs are not supposed to always get a DL data TB but have to keep monitoring. This actually is beneficial for overall system spectrum efficiency when providing almost instant access for sporadic but low-latency URLLC services.

### Core Essence of the Solution

The puncturing information can be implicitly known to the receiver by blindly decode the URLLC data on the overlapping MBB transmission. However, there is always associated trade-offs in terms of blind decoding complexity, the latency arising from grant-based allocation and/or control.

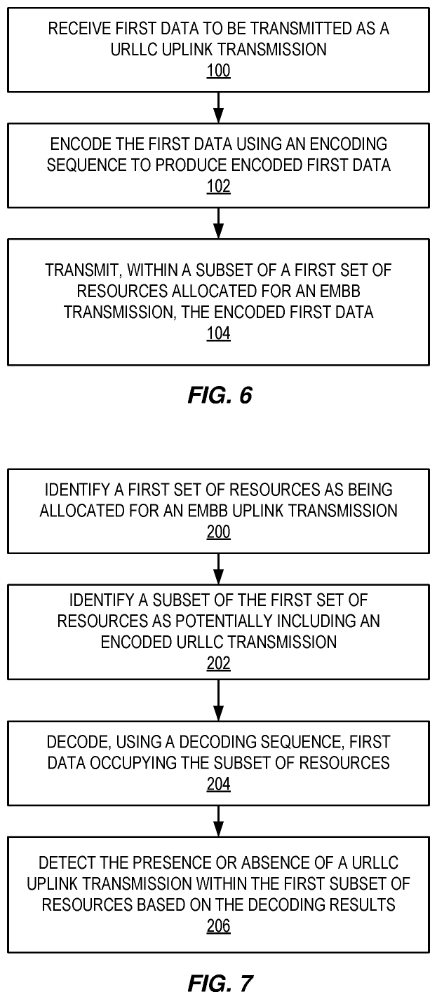

FIG. 6 is a flow chart that illustrates the operation of a User Equipment (UE) or other wireless device according to some embodiments of the present disclosure. In the embodiment illustrated in FIG. 6, the method includes receiving first data to be transmitted as an URLLC uplink transmission (step 100); encoding the first data using an encoding sequence to produce encoded first data (step 102); and transmitting the encoded first data with a subset of a first set of resources that are allocated for an eMBB transmission (step 104).

FIG. 7 is a flow chart that illustrates the operation of a base station or other network node according to some embodiments of the present disclosure. In the embodiment illustrated in FIG. 7, the method includes identifying a first set of resources as being allocated for an eMBB uplink transmission (step 200); identifying a subset of the first set of resources as potentially including an encoded URLLC transmission (step 202); using a decoding sequence to decode first data occupying the identified subset of resources (step 204); and detecting the presence or absence of a URLLC uplink transmission within the first subset of resources based on the decoding results (step 206).

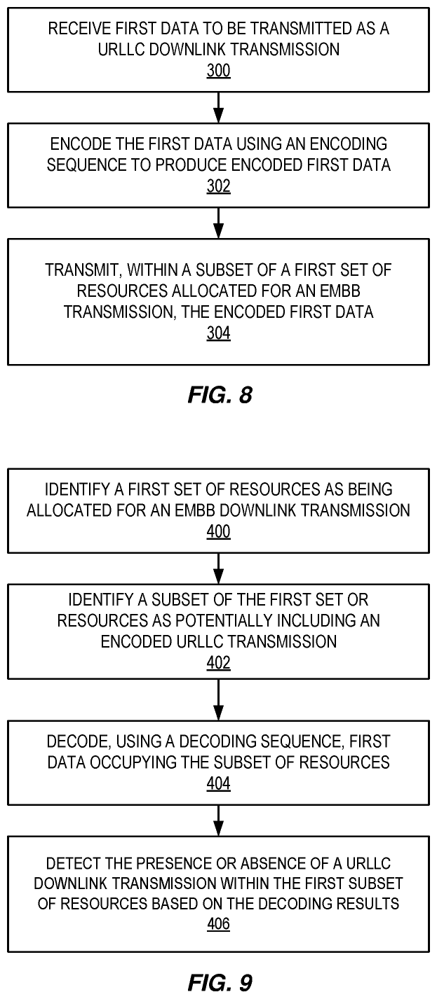

FIG. 8 is a flow chart that illustrates the operation of a base station or other network node according to other embodiments of the present disclosure. In the embodiment illustrated in FIG. 8, the method includes receiving first data to be transmitted as a URLLC downlink transmission (step 300); encoding the first data using an encoding sequence to produce encoded first data (step 302); and transmitting the encoded first data within a subset of a first set of resources allocated for an eMBB transmission (step 304).

FIG. 9 is a flow chart that illustrates the operation of a User Equipment (UE) or other wireless device according to other embodiments of the present disclosure. In the embodiment illustrated in FIG. 9, the method includes identifying a first set of resources as being allocated for an eMBB downlink transmission (step 400); identifying a subset of the first set of resources as potentially including an encoded URLLC transmission (step 402); using a decoding sequence to decode first data occupying the subset of resources; (step 404); and detecting the presence of absence of a URLLC downlink transmission within the first subset of resources based on the decoding results (step 406).

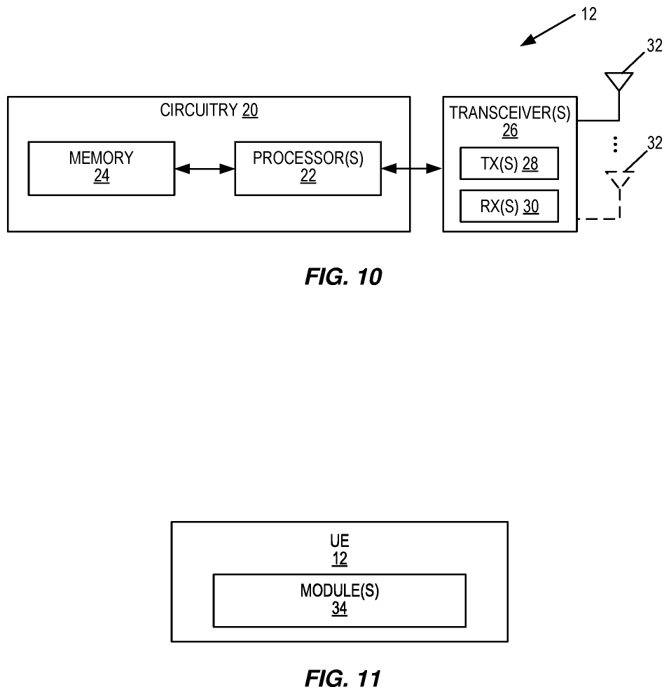

FIG. 10 is a schematic block diagram of a UE 12 according to some embodiments of the present disclosure. As illustrated, the wireless device 12 includes processing circuitry 20 comprising one or more processors 22 (e.g., Central Processing Units (CPUs), Application Specific Integrated Circuits (ASICs), Field Programmable Gate Arrays (FPGAs), Digital Signal Processors(DSPs), and/or the like) and memory 24. The UE 12 also includes one or more transceivers 26 each including one or more transmitters 28 and one or more receivers 30 coupled to one or more antennas 32. In some embodiments, the functionality of the wireless device 12 described above may be implemented in hardware (e.g., via hardware within the circuitry 20 and/or within the processor(s) 22) or be implemented in a combination of hardware and software (e.g., fully or partially implemented in software that is, e.g., stored in the memory 24 and executed by the processor(s) 22).

In some embodiments, a computer program including instructions which, when executed by the at least one processor 22, causes the at least one processor 22 to carry out at least some of the functionality of the wireless device 12 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the wireless device 12 according to some other embodiments of the present disclosure. The UE 12 includes one or more modules 34, each of which is implemented in software. The module(s) 34 provide the functionality of the wireless device 12 described herein (e.g., with respect to FIGS. 6 and 9).

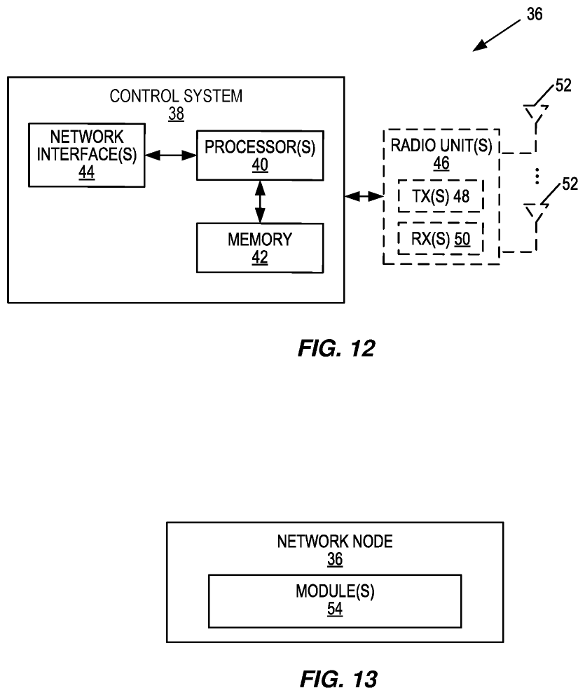

FIG. 12 is a schematic block diagram of a network node 36 (e.g., a radio access node 14) according to some embodiments of the present disclosure. As illustrated, the network node 36 includes a control system 38 that includes circuitry comprising one or more processors 40 (e.g., CPUs, ASICs, DSPs, FPGAs, and/or the like) and memory 42. The control system 38 also includes a network interface 44. In embodiments in which the network node 36 is a radio access node 14, the network node 36 also includes one or more radio units 46 that each include one or more transmitters 48 and one or more receivers 50 coupled to one or more antennas 52. In some embodiments, the functionality of the radio access node 14 described above may be fully or partially implemented in software that is, e.g., stored in the memory 42 and executed by the processor(s) 40.

FIG. 13 is a schematic block diagram of the network node 36 (which may be, e.g., the radio access node 14) according to some other embodiments of the present disclosure. The network node 36 includes one or more modules 54, each of which is implemented in software. The module(s) 54 provide the functionality of the network node 36 described herein.

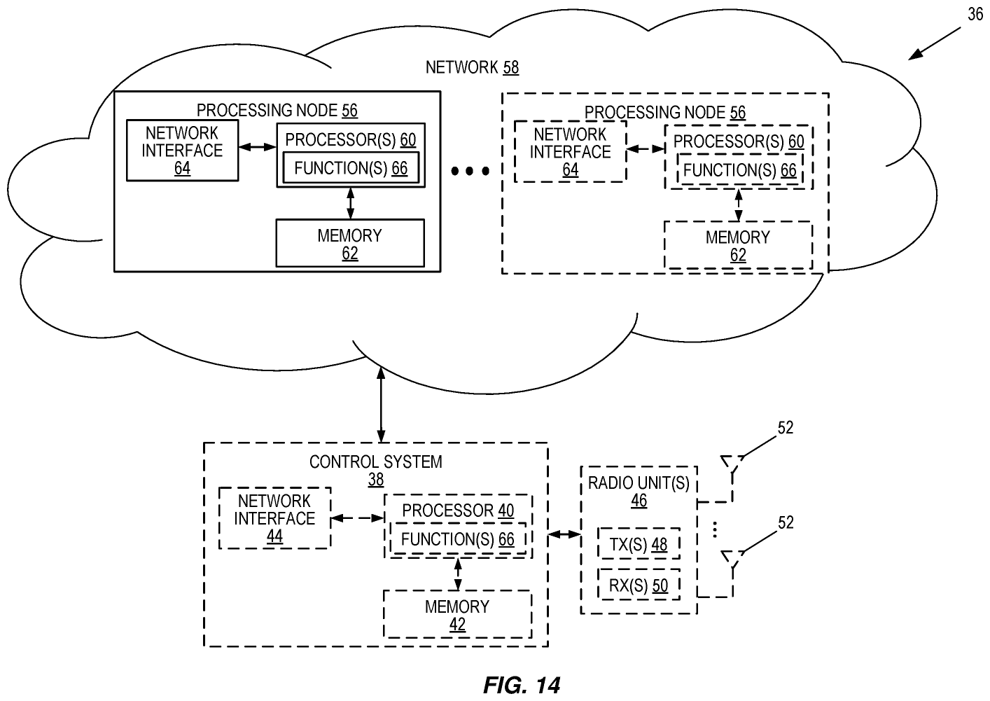

FIG. 14 is a schematic block diagram that illustrates a virtualized embodiment of the network node 36 according to some embodiments of the present disclosure. As used herein, a “virtualized” network node 36 is a network node 36 in which at least a portion of the functionality of the network node 36 is implemented as a virtual component (e.g., via a virtual machine(s) executing on a physical processing node(s) in a network(s)). As illustrated, the network node 36 optionally includes the control system 38, as described with respect to FIG. 12. In addition, if the network node 36 is a radio access node 14, the network node 36 also includes the one or more radio units 46, as described with respect to FIG. 12. The control system 38 (if present) is connected to one or more processing nodes 56 coupled to or included as part of a network(s) 58 via the network interface 44. Alternatively, if the control system 38 is not present, the one or more radio units 46 (if present) are connected to the one or more processing nodes 56 via a network interface(s). Alternatively, all of the functionality of the network node 36 described herein may be implemented in the processing nodes 56 (i.e., the network node 36 does not include the control system 38 or the radio unit(s) 46). Each processing node 56 includes one or more processors 60 (e.g., CPUs, ASICs, DSPs, FPGAs, and/or the like), memory 62, and a network interface 64.

In this example, functions 66 of the radio access node 14 described herein are implemented at the one or more processing nodes 56 or distributed across the control system 38 (if present) and the one or more processing nodes 56 in any desired manner. In some particular embodiments, some or all of the functions 66 of the radio access node 14 described herein are implemented as virtual components executed by one or more virtual machines implemented in a virtual environment(s) hosted by the processing node(s) 56. As will be appreciated by one of ordinary skill in the art, additional signaling or communication between the processing node(s) 56 and the control system 38 (if present) or alternatively the radio unit(s) 46 (if present) is used in order to carry out at least some of the desired functions. Notably, in some embodiments, the control system 38 may not be included, in which case the radio unit(s) 46 (if present) communicates directly with the processing node(s) 56 via an appropriate network interface(s).

In some particular embodiments, higher layer functionality (e.g., layer 3 and up and possibly some of layer 2 of the protocol stack) of the network node 36 may be implemented at the processing node(s) 56 as virtual components (i.e., implemented “in the cloud”) whereas lower layer functionality (e.g., layer 1 and possibly some of layer 2 of the protocol stack) may be implemented in the radio unit(s) 46 and possibly the control system 38.

In some embodiments, a computer program including instructions which, when executed by the at least one processor 40, 60, causes the at least one processor 40, 60 to carry out the functionality of the network node 36 or a processing node 56 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as the memory 62).

The following acronyms are used throughout this disclosure.

3GPP Third Generation Partnership Project

5G Fifth Generation

ACK Acknowledgement

ASIC Application Specific Integrated Circuits

CB Code Block

CBG Code Block Group

CE Control Element

CFI Control Format Indicator

CMTC Critical Machine Type Communication

CPU Central Processing Units

CRC Cyclic Redundancy Check

DCI Downlink Control Information

DL Downlink

DMRS Demodulation Reference Signal

DSP Digital Signal Processors

eMBB Enhanced Mobile Broadband

gNB New Radio Base Station

EPDCCH Enhanced Physical Downlink Control Channel

FPGA Field Programmable Gate Arrays

HARQ Hybrid Automatic Repeat Request

ID Identifier

LTE Long Term Evolution

M2M Machine-to-Machine

MAC Medium Access Control

MCS Modulation and Coding Scheme

MTC Machine Type Communication

NDI Next Data Indicator

NR New Radio

OFDM Orthogonal Frequency Division Multiplexing

PDCCH Physical Downlink Control Channel

PRB Physical Resource Block

QAM Quadrature Amplitude Modulation

QPSK Quadrature Phase Shift Keying

Rel Release

RB Resource Block

RNTI Radio Network Temporary Identifier

RRC Radio Resource Control

SCEF Service Capability Exposure Function

SPS Semi-Persistent Scheduling

SR Scheduling Request

TB Transport Block

TBS Transport Block Size

UE User Equipment

UE-ID User Equipment Identifier

UL Uplink

URLLC Ultra Reliable Low Latency Communication

VRB Virtual Resource Block

Those skilled in the art will recognize improvements and modifications to the embodiments of the present disclosure. All such improvements and modifications are considered within the scope of the concepts disclosed herein.

1-48. (canceled)

49. A method of operation of a radio node for puncturing an Enhanced Mobile Broadband, eMBB, transmission with an Ultra Reliable Low Latency Communication, URLLC, transmission, the method comprising:
receiving first data to be transmitted as an URLLC transmission;
encoding the first data using an encoding sequence to produce encoded first data; and
transmitting, within a subset of a first set of resources allocated for the eMBB transmission, the encoded first data.

50. The method of claim 49 wherein encoding the first data using the encoding sequence comprises performing a bitwise operation of the encoding sequence with a Cyclic Redundancy Check, CRC, portion and/or a data portion of the first data.

51. The method of claim 50 wherein performing the bitwise operation of the encoding sequence with the CRC portion and/or the data portion of the first data comprises performing one of: a modulo-2 addition; and an exclusive OR, XOR, operation.

52. The method of claim 49 wherein encoding the first data using the encoding sequence comprises scrambling the first data using a pseudo-random sequence, where the pseudo-random sequence is generated as a function of the encoding sequence.

53. The method of claim 49 wherein the encoding sequence comprises or is generated based on at least one of: a UE identifier, UE-ID; a Radio Network Temporary Identifier, RNTI; a cell identifier; and a traffic identifier.

54. The method of claim 49 wherein a location of the subset of the first set of resources is pre-configured, dynamically selected, and/or signaled.

55. The method of claim 49 wherein the radio node is a User Equipment, UE, and the URLLC transmission is an URLLC uplink transmission.

56. The method of claim 55 wherein the first set of resources was allocated for an eMBB transmission by the UE.

57. The method of claim 56 wherein transmitting the encoded first data punctures the eMBB transmission by the UE.

58. The method of claim 55 wherein the first set of resources was allocated for an eMBB transmission by a second UE.

59. The method of claim 58 wherein the UE is a member of a group of UEs and wherein the first UE can puncture the second UE only if the second UE is a member of the group of UEs.

60. The method of claim 59 wherein the UE is a URLLC-capable UE and the other UEs in the group of UEs are not URLLC-capable.

61. The method of claim 58 wherein transmitting the encoded first data punctures the eMBB transmission by the second UE.

62. The method of claim 61 wherein the eMBB transmission by the second UE is at a first transmission power and wherein transmitting the encoded first data comprises transmitting the encoded first data at a second transmission power higher than the first transmission power.

63. The method of claim 49 wherein the radio node is a network node, and the URLLC transmission is an URLLC downlink transmission.

64. The method of claim 63 wherein the first set of resources was allocated for the eMBB transmission to a User Equipment, UE.

65. The method of claim 64 wherein transmitting the encoded first data punctures the eMBB transmission to the User Equipment, UE.

66. The method of claim 63 wherein the first set of resources was allocated for an eMBB transmission to a second UE.

67. The method of claim 66 wherein transmitting the encoded first data punctures an eMBB transmission to the second UE.

68. The method of claim 67 wherein the eMBB transmission to the second UE is at a first transmission power and wherein transmitting the encoded first data comprises transmitting the encoded first data at a second transmission power higher than the first transmission power.

69. A method of operation of a radio node for detecting that an Enhanced Mobile Broadband, eMBB, transmission has been punctured by an Ultra Reliable Low Latency Communication, URLLC, transmission, the method comprising:
identifying a first set of resources as being allocated for an eMBB transmission;
identifying a subset of the first set of resources as potentially including an encoded URLLC transmission;
decoding, using a decoding sequence, first data occupying the subset of resources; and
detecting the presence or absence of a URLLC transmission within the subset of resources based on the decoding results.

70. The method of claim 69 wherein decoding the first data occupying the subset of resources using the decoding sequence comprises:
calculating a Cyclic Redundancy Check, CRC, value for a first portion of the first data; and
performing a bitwise operation of the calculated CRC value and a second portion of the first data;
wherein, if the results of the operation match the decoding sequence, the first data contains the URLLC transmission.

71. The method of claim 70 wherein performing the bitwise operation of the calculated CRC value and the second portion of the first data comprises performing one of: a modulo-2 addition; and an exclusive OR, XOR, operation.

72. The method of claim 69 wherein decoding the data occupying the subset of resources using the decoding sequence comprises:
de-scrambling the first data using a pseudo-random sequence to produce second data, where the pseudo-random sequence is generated as a function of the decoding sequence; and
determining whether the second data contains the URLLC transmission.

73. The method of claim 72 wherein determining whether the second data contains a URLLC transmission comprises:
calculating a Cyclic Redundancy Check, CRC, value for a first portion of the second data; and
determining whether the calculated CRC value matches a second portion of the second data.

74. The method of claim 69 wherein the encoding sequence comprises or is generated based on at least one of: a User Equipment, UE, identifier, UE-ID; a Radio Network Temporary Identifier, RNTI; a cell identifier; and a traffic identifier.

75. The method of claim 69 wherein at least one of:
a location of the subset of the first set of resources; and
an expected length of encoded URLLC transmissions
is pre-configured, dynamically selected, and/or signaled.

76. The method of claim 69 wherein detecting the presence or absence of the URLLC transmission within the subset of resources comprises detecting the presence or absence of the URLLC transmission based on whether a power level of the subset of resources is higher than a power level of the first set of resources other than the subset of resources.

77. The method of claim 69 wherein the radio node is a network node.

78. The method of claim 77 wherein the network node performs the decoding step using a decoding sequence associated with the User Equipment, UE.

79. The method of claim 77 wherein the network node performs the decoding step using a decoding sequence associated with a second User Equipment, UE, different from the UE.

80. The method of claim 77 wherein the network node performs the decoding and detecting steps for each of a plurality of User Equipments, UEs, each decoding and detecting step performed using a decoding sequence associated with the associated one of the plurality of UEs.

81. The method of claim 69 wherein the radio node is a User Equipment, UE.

82. The method of claim 81 wherein the first set of resources was allocated for the eMBB transmission to the UE.

83. The method of claim 82 wherein the first set of resources was allocated for the eMBB transmission to a second UE.

84. A radio node for puncturing an Enhanced Mobile Broadband, eMBB, transmission with an Ultra Reliable Low Latency Communication, URLLC, transmission, the radio node comprising:
processing circuitry configured to cause the radio node to:
receive first data to be transmitted as an URLLC transmission;
encode the first data using an encoding sequence to produce encoded first data; and
transmit, within a subset of a first set of resources allocated for the eMBB transmission, the encoded first data.

85. A radio node for detecting that an Enhanced Mobile Broadband, eMBB, transmission has been punctured by an Ultra Reliable Low Latency Communication, URLLC, transmission, the radio node comprising:
processing circuitry configured to cause the radio node to:
identify a first set of resources as being allocated for an eMBB transmission;
identify a subset of the first set of resources as potentially including an encoded URLLC transmission;
decode, using a decoding sequence, first data occupying the subset of resources; and
detect the presence or absence of a URLLC transmission within the subset of resources based on the decoding results.
